(19) United States
(12) Patent Application Publication
(10) Pub. No.: US 2023/0070476 A1
(43) Pub. Date: Mar. 9, 2023

(54) HIGH THROUGHPUT SURFACE ION SOURCE FOR SEPARATION OF RADIOACTIVE AND STABLE LANTHANIDE ISOTOPES

(71) Applicant: The Curators of the University of Missouri, Columbia, MO (US)

(72) Inventors: John Gahl, Columbia, MO (US); John David Robertson, Sturgeon, MO (US); Peter Norgard, Columbia, MO (US); Brad Jeffries, Columbia, MO (US); Valentina O'Donnell, Columbia, MO (US)

(73) Assignee: The Curators of the University of Missouri, Columbia, MO (US)

(21) Appl. No.: 17/589,382

(22) Filed: Jan. 31, 2022

Related U.S. Application Data
(60) Provisional application No. 63/241,619, filed on Sep. 8, 2021.

(51) Int. Cl. G21G 1/00; G21G 1/02; B01D 59/48

(52) U.S. Cl. CPC G21G 1/001; G21G 1/02; B01D 59/48; G21G 2001/0094

(57) ABSTRACT

The present invention is directed to processes for ionizing one or more lanthanide isotopes, processes for separating lanthanide isotopes, various apparatus and systems useful for these processes, and compositions prepared from these processes.

### CROSS REFERENCE TO RELATED APPLICATIONS

This application claims the benefit of U.S. Provisional Patent Application No. 63/241,619, filed Sep. 8, 2021, the entire contents of which are incorporated herein by reference.

### STATEMENT REGARDING FEDERALLY SPONSORED RESEARCH OR DEVELOPMENT

This invention was made with Government support under DESC0019218 awarded by the Department of Energy. The Government has certain rights in the invention.

### FIELD OF THE INVENTION

The present invention is directed to various processes for ionizing one or more lanthanide isotopes, processes for separating lanthanide isotopes, apparatus and systems useful for these processes, and compositions prepared from these processes.

### BACKGROUND OF THE INVENTION

Radiolanthanides are important for radiotherapies and radiodiagnostics in the treatment and imaging of various cancers. For example, the radiopharmaceutical compound ¹⁵³Sm-ethylenediamine tetramethylene phosphonate (¹⁵³Sm-EDTMP) is an important therapeutic approved in the United States and Europe to treat painful bone metastasis (Handkiewicz-Junak et al., European Journal of Nuclear Medicine and Molecular Imagining 45, 846-859, 2018).

Isotopes destined for medical applications often possess short half-lives, typically a few days for lanthanides, to enhance the radiation dose delivered to the target cells while limiting patient exposure. A short half-life requires an efficient pipeline from isotope creation to dose administration. Clearly, for the isotope separation method to be successful for this application, it must perform its work quickly relative to the half-life of the isotope.

Electromagnetic separation is technique that is currently used to separate isotopes. Electromagnetic separation discriminates materials based on their charge-to-mass ratio, permitting a well-designed system to differentiate between isotopes of the same element. The success of the separation method depends heavily upon the ion beam quality, which starts at the ion source.

In the early 1970's, P. G. Johnson and others at Lawrence Livermore Laboratory built such ion sources for actinides and lanthanides. FIG. 1 and FIG. 2 show the compact ion source with its enclosed crucible. However, the tip of the crucible had to be heated to approximately 3000° C., which was achieved by electron bombardment from a tantalum filament's thermionic emission. High temperatures were required to volatilize the oxides of the lanthanides that were loaded into the tungsten crucible. The temperature at the oxide sample was several hundred degrees lower than at the tip to ensure the lanthanide would not plate out before it exited the crucible.

There remains a need for simplified processes that can produce high purity radiolanthanides at high throughput (e.g., in a reduced amount of time and that do not require excessively high temperatures (e.g., 3,000° C.)) while reducing the amount of radiation that reactor operators may be exposed to during production.

### BRIEF SUMMARY OF THE INVENTION

Various aspects of the present invention are directed to processes for ionizing isotopes of a lanthanide. In various embodiments, the processes comprise heating a mixture comprising a plurality of isotopes of the same lanthanide (e.g., a first isotope and a second isotope) in a crucible that is comprised of a metal that does not readily activate in a neutron field to ionize the plurality of lanthanide isotopes.

Further aspects are directed to processes for separating isotopes of a lanthanide. In some embodiments, the processes comprise heating a mixture comprising a plurality of isotopes of the same lanthanide (e.g., a first isotope and a second isotope) in a crucible comprised of a metal that does not readily activate in a neutron field to ionize the plurality of lanthanide isotopes; and electromagnetically separating the plurality of ionized lanthanide isotopes to form a plurality of distinct fractions comprising a first fraction comprising at least a portion of a first isotope of the lanthanide and a second fraction comprising at least a portion of a second isotope of the lanthanide, wherein the concentration of the first isotope of the lanthanide in the first fraction is greater than the concentration of the first isotope of the lanthanide in the second fraction.

Other aspects are directed to apparatus for ionizing one or more lanthanide isotopes. In various embodiments, the apparatus comprises a crucible comprised of a metal that does not readily activate in a neutron field and a heater configured to heat the crucible.

Still further aspects of the present invention are directed to a system for producing a lanthanide isotope. The system comprises the apparatus or ionizing one or more lanthanide isotopes, as described herein, in fluid communication with an electromagnetic isotope mass separator.

Additional aspects relate to a composition comprising¹⁵³Sm or a compound comprising¹⁵³Sm, wherein the composition has a specific activity of about 10 Ci/mg or greater, about 25 Ci/mg or greater, about 50 Ci/mg or greater, about 100 Ci/mg or greater, about 200 Ci/mg or greater, about 300 Ci/mg or greater, or about 400 Ci/mg or greater.

Other objects and features will be in part apparent and in part pointed out hereinafter.

### BRIEF DESCRIPTION OF THE DRAWINGS

FIG. 1: A complete ion source with vacuum flange and sample insertion tube.

The cutaway shows the source with crucible in place.

FIG. 2: Sample crucible and cap showing sample position.

FIG. 3: A diagram of the titanium surface ionization source assembled for resistive heating.

FIG. 4: Samarium ion current produced by the prototype titanium surface ion source with a 70 A heating current.

FIG. 5: Thermocouple measurements inside of the crucible cavity with a 70 A heating current are shown together with the samarium ion current.

### DETAILED DESCRIPTION OF THE INVENTION

The present invention is directed to various processes for ionizing one or more lanthanide isotopes, processes for separating lanthanide isotopes, apparatus and systems useful for these processes, and compositions prepared from these processes.

The processes and apparatus of the present invention are useful in producing high specific activity isotopes. Central to this aspect is a high throughput surface ion source, with applicability to lanthanides. The goal is to use neutron irradiated lanthanide targets and electromagnetically separate radioactive species from the target material. For example, the radioactive isotope¹⁵³ Sm (ti/2=1.928 d) can be separated from the stable target material¹⁵²Sm. The radiopharmaceutical compound ¹⁵³Sm-ethylenediamine tetramethylene phosphonate (¹⁵³Sm-EDTMP) is an important therapeutic. ¹⁵³ Sm is currently produced through the irradiation of 99% enriched¹⁵²Sm targets. This approach yields¹⁵³Sm with a specific activity on the order of 5 Ci/mg. Electromagnetically separating¹⁵³Sm from the target material can create a product that approaches theoretical specific activity of 440 Ci/mg.

Some lanthanide metals, including samarium and ytterbium, have a high vapor pressure and a high evaporation rate at relatively low temperatures. The significance of this reduced temperature is that a crucible can advantageously be made out of a metal such as titanium and/or vanadium. Titanium, which doesn't readily activate under a neutron field, has a melting temperature of approximately 1600° C., and a work function similar to tantalum. Titanium can be directly inserted into a nuclear reactor with a pre-loaded non-radioactive material. As a result, target irradiation can be seamlessly integrated with isotope separation, eliminating any post irradiation sample manipulation, which is a particularly critical issue for short lived isotopes.

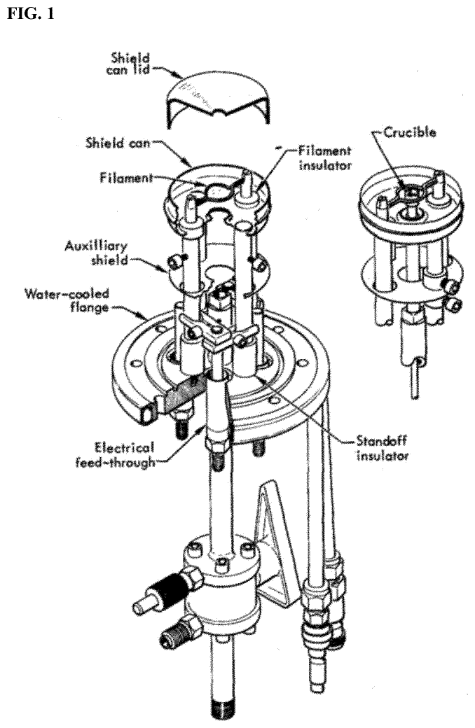

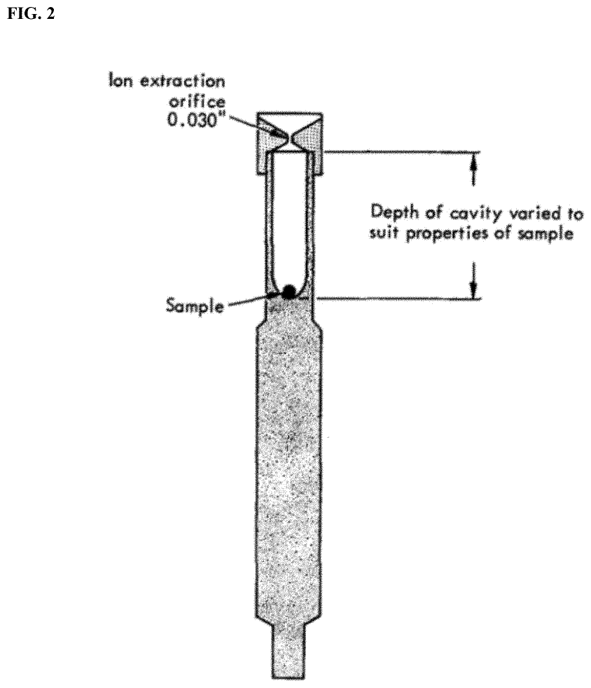

A crucible and an ion extraction orifice made entirely of titanium was constructed and operated as a surface ion source. The first variant operated on a test stand was similar to the device shown in FIG. 1 and FIG. 2, except that titanium was used instead of tungsten. Metal samarium was volatized in the crucible and simple beam optics directed a beam toward a Faraday cup or a graphite target for later analysis by laser ablation ICP mass spectrometry.

Ion sources based on the surface ionization principle are particularly successful for production of singly charged positive and negative radioactive ion beams for use in mass separators due to their simplicity, high efficiency, and selectivity. Hot-cavity surface ionization sources are often utilized in Isotope Separation On-Line (ISOL) facilities.

The ionizer material is usually made of a refractory metal, such as tantalum or tungsten, and heated to a high working temperature. The probability of ionization occurring for an atom colliding with the walls of a hot ionizer depends on the Saha-Langmuir formula as:

$$α = [ G exp ( \frac{- ( {V}_{i} - {φ}_{e} )}{k T} ) ]$$

where Vi is the ionization potential of the atom, T is temperature, k is the Boltzmann coefficient, ye is the work function of the ionizer and G are statistical weights of the ground levels of the species related to their total spin numbers. A surface ionizer is significantly more efficient when its work function approaches the ionization potential of the material to be ionized. Although titanium has a lower melting point temperature than tungsten and tantalum, it has a similar work function (Table 1). It has been found that titanium is suitable as a surface ionizer for lanthanide metals that have large vapor pressures and evaporation rates at relatively low temperatures (Table 2).

TABLE 1
Comparison of properties of titanium with tungsten and tantalum.

| | Ionization Potential, | Work Function, | Melting Point |
|---|---|---|---|
| Ionizer | V (eV) | φ (eV) | (K) |
| Ti | 6.83 | 4.33 | 1941 |
| W | 7.86 | 4.54 | 3695 |
| Ta | 7.55 | 4.25 | 3290 |

TABLE 2

| | | Temperature at 700 K | |
|---|---|---|---|
| | Ionization Potential, | Vapor Pressure | Evaporation Rate |
| Lanthanide | V (eV) | (Pa) | (per m²s) |
| Sm | 5.64 | 3.50 × 10⁻⁵ | 2.8 × 10¹⁷ |
| Yb | 6.25 | 0.270 | 2.0 × 10²¹ |
| Y | 6.21 | 2.50 × 10⁻²⁰ | 260 |

A major advantage of using titanium is that unlike tantalum or tungsten, neutron capture on titanium produces only one short-lived isotope (⁵¹Ti, ti/2=5.76 m). By constructing the surface ion source from titanium, it is possible to load lanthanide materials into the surface ion source prior to irradiation. The titanium surface ion source could then be removed from the nuclear reactor following irradiation already loaded with an activated lanthanide and quickly installed into the electromagnetic isotope separator, saving valuable time and operator dose.

Prior surface ionization sources fabricated from tungsten were developed at Lawrence Livermore National Laboratory (LLNL) in the early 1970's. At the time, the lanthanide samples to be ionized were in oxide form, which meant the samples contained inside of the cavity needed to reach high temperatures to achieve adequate evaporation rates (3100-3600 K). However, samarium metal is now commercially available and relatively inexpensive. Since samarium metal has a relatively large vapor pressure at lower temperatures, the evaporation rates are sufficiently large at temperatures much lower than the source used in the LLNL design.

Previously, heating was achieved with a tantalum filament placed at the extraction-end of the crucible. A current of approximately 40 A was passed through the filament, resulting in the emission of thermionic electrons. The entire crucible was held at a positive potential of 5 kV, and thus the electrons emitted by the filament at near ground potential accelerated and impacted the tip of the crucible. This also sputtered tungsten from the crucible. To protect the system from contamination, a shield was assembled to enclose the filament and crucible. Our experiments have found that heating using electron bombardment produces tantalum contamination in the system. Laser ablation inductively coupled plasma mass spectroscopy performed on samples of graphite placed in-line with the crucible detected the tantalum. Deposits of tantalum had evaporated from the filament, despite having a shield.

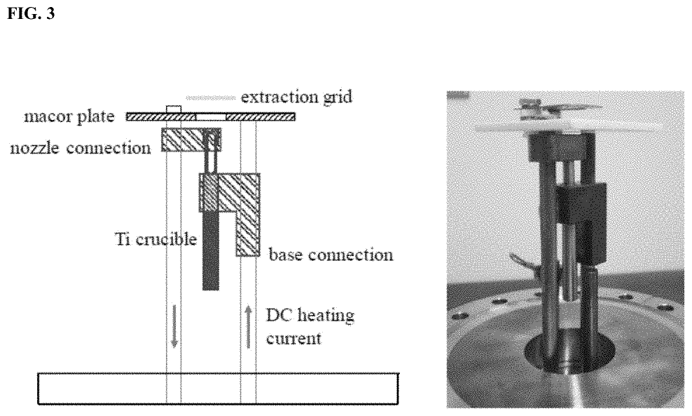

In the processes of the present invention, ohmic heating can be use rather than electron bombardment heating. In this new configuration, the cavity and the nozzle are heated by a DC electrical current that passes through the cavity from the base to the nozzle (FIG. 3). This current produces a small electric field inside the crucible, assisting in ion ejection, which is an important effect. This new heating configuration also eliminates tantalum contamination in the system.

Processes of the present invention incorporate one or more of these discoveries. For example, various processes of the present invention are useful for ionizing (and volatilizing) one or more lanthanide isotopes. These processes can comprise heating the one or more lanthanide isotopes (e.g., a mixture comprising a plurality of isotopes of the same lanthanide) in a crucible that is comprised of a metal that does not readily activate in a neutron field to ionize the one or more lanthanide isotopes.

Various processes are also useful for separating isotopes of a lanthanide and/or producing one or more fractions enriched in an isotope of the lanthanide. In some embodiments, the processes comprise heating a mixture comprising a plurality of isotopes of the same lanthanide (e.g., a first isotope of the lanthanide and a second isotope of the lanthanide) in a crucible comprised of a metal that does not readily activate in a neutron field to ionize (and volatilize) the plurality of lanthanide isotopes; and electromagnetically separating the plurality of ionized lanthanide isotopes to form a plurality of distinct fractions, wherein the concentration of a first isotope of the lanthanide in a first fraction is enriched relative to the concentration of the first isotope of the lanthanide in the plurality of ionized lanthanide isotopes subjected to electromagnetic separation and/or the concentration of a first isotope of the lanthanide in a first fraction is enriched relative to the concentration of the first isotope in the other fractions of the plurality of distinct fractions. For example, in one embodiment, the plurality of ionized lanthanide isotopes are electromagnetically separated to form a first fraction comprising at least a portion of a first isotope of the lanthanide and a second fraction comprising at least a portion of a second isotope of the lanthanide, wherein the concentration of the first isotope of the lanthanide in the first fraction is greater than the concentration of the first isotope of the lanthanide in the second fraction.

As noted, a direct current can be applied to the crucible to heat the crucible to a temperature wherein at least a portion of the lanthanide isotope(s) volatilizes. In some embodiments, the crucible has a work function similar to the lanthanide such that, upon heating of the crucible, the vaporized lanthanide is ionized by the crucible. In various embodiments, the crucible can be heated to a maximum temperature of about 1500° C. or less, about 1400° C. or less, about 1300° C. or less, about 1200° C. or less, or about 1100° C. or less. For example, the crucible can be heated to a temperature of from about 500° C. to about 1500° C., from about 600° C. to about 1400° C., from about 700° C. to about 1300° C., from about 800° C. to about 1200° C., or from about 900° C. to about 1100° C.

In various embodiments, the crucible is comprised of titanium and/or vanadium. In certain embodiments, the crucible is constructed primarily or entirely of titanium and/or vanadium.

The processes described herein can further include the step of irradiating a lanthanide target material in a nuclear reactor to form the mixture comprising a plurality of isotopes of the lanthanide, wherein the lanthanide target material is irradiated while held within the crucible constructed of a metal that does not readily activate in a neutron field.

The processes described herein can be used to ionize and/or separate various lanthanides and lanthanide isotopes (e.g., samarium, ytterbium, etc.). In various embodiments, the lanthanide comprises samarium. In certain embodiments, the lanthanide isotopes comprise ¹⁵²Sm and ¹⁵³Sm. Accordingly, in various separation processes, the first fraction and/or second fraction can comprise a radioisotope. For example, in some embodiments, the first fraction is enriched in ¹⁵³Sm and/or the second fraction is enriched in ¹⁵²Sm.

As noted, the processes and apparatus of the present invention are useful in producing high specific activity isotopes. For example, the first or second fraction can have a specific activity of about 10 Ci/mg or greater, about 25 Ci/mg or greater, about 50 Ci/mg or greater, about 100 Ci/mg or greater, about 200 Ci/mg or greater, about 300 Ci/mg or greater, or about 400 Ci/mg or greater.

Apparatus and systems of the present invention also incorporate one or more of the aforementioned discoveries. In various embodiments, the apparatus for ionizing one or more lanthanide isotopes comprises a crucible comprised of a metal that does not readily activate in a neutron field and a heater configured to heat the crucible. In some embodiments, the crucible is comprised of titanium and/or vanadium. In certain embodiments, the crucible is constructed primarily (e.g., >50% or even >75%) or entirely of titanium and/or vanadium.

In some embodiments, the heater comprises a DC heating circuit.

In further embodiments, the apparatus further comprises a nozzle or orifice (e.g., for fluid connection to an electromagnetic isotope mass separator).

Further, systems for producing a lanthanide isotope comprise the apparatus for ionizing one or more lanthanide isotopes, as described herein, in fluid communication with an electromagnetic isotope mass separator (e.g., a mass spectrometer). The system can further comprise a nuclear reactor or other isotope-producing device/reactor.

Compositions of the present invention can be enriched in a lanthanide isotope. In some embodiments, the composition comprises ¹⁵³Sm or a compound comprising ¹⁵³Sm, wherein the composition has a specific activity of about 10 Ci/mg or greater, about 25 Ci/mg or greater, about 50 Ci/mg or greater, about 100 Ci/mg or greater, about 200 Ci/mg or greater, about 300 Ci/mg or greater, or about 400 Ci/mg or greater.

The compositions can used be for therapeutic or diagnostic purposes. In some embodiments, the composition can further include one or more pharmaceutically acceptable excipients.

Having described the invention in detail, it will be apparent that modifications and variations are possible without departing from the scope of the invention defined in the appended claims.

### EXAMPLES

The following non-limiting example(s) are provided to further illustrate the present invention.

### Example 1

A crucible and capped nozzle were constructed from a 6.35 mm titanium rod (99.7%, Alfa Aesar) with the same dimensions as the original Livermore design. The crucible cavity was 15.9 mm deep with a 3.18 mm inner diameter and a wall thickness of 1.6 mm. The nozzle had a 0.7 mm diameter extraction aperture (FIG. 3). The stainless-steel connectors, which ran the heating current through the crucible, doubled as a holder, keeping the crucible centered between the molybdenum rods of the vacuum feedthrough.

A 19.5 mg sample of natural samarium foil 0.127 mm in thickness (99.9%, Alfa Aesar) was confined inside of the crucible cavity. The sample was kept under an inert environment before being loaded into the test stand in order to prevent oxidation. The ion source was installed on a multi-port, stainless-steel high vacuum chamber consisting of a remotely actuated Faraday cup, a hot cathode vacuum gauge (Kurt J. Lesker 351 Series) and a vacuum viewport. The vacuum pressure inside the test stand was maintained in the range of 10′-10⁻⁵ Torr. The crucible was resistively heated with a constant current of 70 A (TDK-Lambda GEN1500). A positive bias voltage of 5 kV was applied to the crucible (Glassman HV Inc. EW30R20).

Ions were extracted from the tip of the nozzle with rudimentary optics: a flat, gridded extraction electrode with an elliptical opening that was placed 12.7 mm from the tip of the nozzle. The dimensions of the major and minor axis of the elliptical opening was 12.7 mm and 9 mm, respectively. The electrode was grounded through the fourth molybdenum post on the vacuum flange and held in place on a Macor machinable ceramic plate.

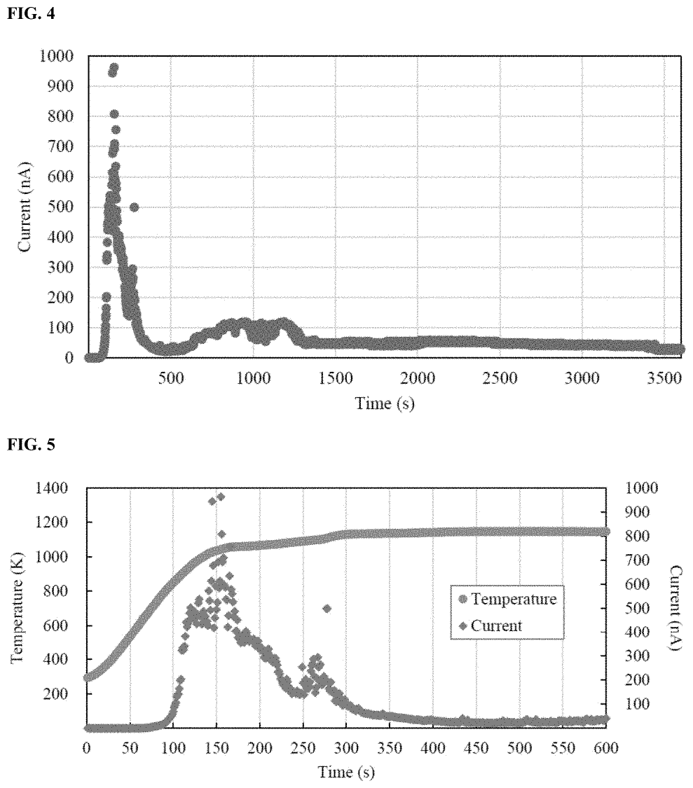

The samarium ion current was measured for ions striking a square nickel plate with an area of 53 cm² attached to the frame of a Faraday cup. The plate was connected to a picoammeter (Keithley 6485), which has a 10 fA resolution. The plate was 80 mm from the tip of the nozzle. In addition to current measurements, laser ablation mass spectroscopy was performed on graphite samples attached to the nickel plate. The temperature along the length of the crucible was measured using an optical pyrometer (PYRO Inc. Micro-Therm). Following the ion source test, an identical heating procedure was conducted on an empty crucible, and temperature measurements inside the cavity of the crucible were taken with a K-type single-ended thermocouple probe (FIG. 4). The tip of the probe contacted the surface inside the cavity where the samarium foil was placed.

The samarium ion current was detected after 60 seconds of applying the heating current. After approximately 100 seconds, the ion current increased dramatically, reaching a peak current of 960 nA at 150 seconds. Following the peak, the ion current quickly dropped to approximately 20 nA. A second, smaller peak of 100 nA occurred at 800 seconds.

The temperature measurements taken with the pyrometer found that the tip of the nozzle and the base of the crucible both reached an equilibrium temperature of approximately 1150 K. There was not a significant temperature gradient along the length of the crucible. A full element scan on the graphite samples placed in-line with the source using laser ablation mass spectroscopy did not detect any titanium or tantalum deposits. Only samarium and trace amounts of the rare earth metals were detected.

FIG. 5 illustrates the temporal development of the samarium ion current alongside the crucible temperature measured with a thermocouple. Most of the heating occurred within the 300 seconds of applying the resistive current. The crucible began at room temperature (293 K) and reached 600 K after 60 seconds. After 180 seconds, the crucible was 1060 K and gradually reached an equilibrium temperature of 1145 K after 400 seconds of heating.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions, processes, and apparatus without departing from the scope of the invention, it is intended that all matter contained in the above description and shown in the accompanying drawings shall be interpreted as illustrative and not in a limiting sense.

### REFERENCES

Alcock, C. B., Itkin, V. P., and Horrigan, M. K., Canadian Metallurgical Quarterly, 23, 309, 1984. 10.1179 cmq.1984.23.3.309

Alton, G.D., R. F. Welton, R.F., B. Cui, B., S. N. Murray, S.N., Mills, G. D., 1998. A new concept of positive (negative) surface ionization source equipped with high porosity ionizer, Nucl. Inst. Meth. B 142:578. 10.1016/S0168-583X(98)00339-5

Bjornstad, T., Hagebo, E., Hoff, P., Jonsson, O.C., Kugler, E., Ravn, H. L., Sundell, S., Vosicki, B., and the ISOLDE Collaboration. 1986. Methods for production of intense beams of unstable nuclei: new developments at ISOLD, Physica Scripta 34. 10.1088/0031-8949/34/6A/013

Brown, LG., 2004. The Physics and Technology of Ion Sources, 2nd Edition, Wiley-VHC, 8-10. 10.1002/3527603956

Handkiewicz-Junak, D., Poeppel, T.D., Bodei, L., Aktolun, C., Ezziddin, S., Giammarile, F., Delgado-Bolton, R. C., 2018. EANM guidelines for radionuclide therapy of bone metastases with beta-emitting radionuclides. European Journal of Nuclear Medicine and Molecular Imagining 45. 846-859. 10.1007/s00259-018-3947-x

Haynes, W. M., Lide, D. R., & Bruno, T. J. (2016). CRC handbook of chemistry and physics: a ready-reference book of chemical and physical data. 2016-2017, 97th Edition /Boca Raton, Fla.: CRC Press.

Johnson, P.G., Bolson, A., Henderson, C. M., 1972. A High Temperature Ion Source For Isotope Separators. Nuclear Instruments and Methods 106, 83-87. 10.1016/0029-554X(73)90049-9

Liu, Y., Baktash, C., Beene, J.R., Havener, C.C., Krause, H.F., Schultz, D.R., Strancener, D.W., Vane, C.R., Geppert, Ch., Kessler, T., Wies, K., Wendt, K., 2011. Time profiles of ions produced in a hot-cavity resonant ionization laser ion source. Nuclear Instruments and Methods in Physics Research B 269. 2711-2780. 10.1016/j.nimb.2011.08.009

Manzolaro, M., D'Agostini, F., Monetti, A., Andrighetto, A., 2017. The SPES surface ionization source. Review of Scientific Instruments 88. 10.1063/1.4998246

Mishin, V.I., Fedoseyev, V.N., Kluge, H.-J., Letokhov, V.S., Ravn, H.L., Scheerer, F., Shirakabe, Y., Sundell, S., Tengblad, 0., 1993. Chemically selective laser ion-source for the CERN-ISOLDE on-line mass separator facility. Nuclear Instruments and Methods in Physics Research Section B: Beam Interactions with Materials and Atoms 73. 550-560. 10.1016/0168-583X(93)95839-W

Park, S.J., Hong, S.G., Ishiyama, H., Hwang, W., Jeong, J.W., Lee, J.-H., Seo, C.S., Kang, B.-H., Tshoo, K., Woo, H.J., Joung, M.J., Kim, J.Y., Jeong, S.C., 2017. Rb and Cs ionization efficiency measurements for the RISP surface ionization source. Nuclear Instruments and Methods in Physics Research Section B: Beam Interactions with Materials and Atoms. 410, 108-113. 10.1016/j.nimb.2017.08.010

What is claimed:

1. A process for separating isotopes of a lanthanide, the process comprising:
heating a mixture comprising a plurality of isotopes of the same lanthanide in a crucible comprised of a metal that does not readily activate in a neutron field to ionize the plurality of lanthanide isotopes; and
electromagnetically separating the plurality of ionized lanthanide isotopes to form a first fraction comprising at least a portion of a first isotope of the lanthanide and a second fraction comprising at least a portion of a second isotope of the lanthanide, wherein the concentration of the first isotope of the lanthanide in the first fraction is greater than the concentration of the first isotope of the lanthanide in the second fraction.

2. The process of claim 1, further comprising irradiating a lanthanide target material in a nuclear reactor to form the mixture comprising a plurality of isotopes of the lanthanide, wherein the lanthanide target material is irradiated while held within the crucible comprised of a metal that does not readily activate in a neutron field.

3. The process of claim 1 wherein a direct current is applied to the crucible to heat the crucible to a temperature at which at least a portion of the plurality of lanthanide isotopes volatilizes.

4. The process of claim 3 wherein the crucible comprises a metal having a work function similar to the lanthanide such that, upon heating the crucible, the vaporized lanthanide is ionized by the crucible.

5. The process of claim 1 wherein the crucible is comprised of titanium and/or vanadium.

6. The process of claim 1 wherein the crucible is constructed primarily or entirely of titanium and/or vanadium.

7. The process of claim 1 wherein the lanthanide comprises samarium.

8. The process of claim 1 wherein the plurality of lanthanide isotopes comprises ¹⁵²Sm and ¹⁵³Sm.

9. The process of claim 1 wherein the first fraction comprises a radioisotope of the lanthanide.

10. The process of claim 8 wherein the first fraction comprises ¹⁵³Sm.

11. The process of claim 9 wherein the first fraction has a specific activity of about 10 Ci/mg or greater, about 25 Ci/mg or greater, about 50 Ci/mg or greater, about 100 Ci/mg or greater, about 200 Ci/mg or greater, about 300 Ci/mg or greater, or about 400 Ci/mg or greater.

12. The process of claim 1 wherein the crucible is heated to a maximum temperature of about 1500° C. or less, about 1400° C. or less, about 1300° C. or less, about 1200° C. or less, or about 1100° C. or less.

13. The process of claim 1 wherein the crucible is heated to a temperature of from about 500° C. to about 1500° C., from about 600° C. to about 1400° C., from about 700° C. to about 1300° C., from about 800° C. to about 1200° C., or from about 900° C. to about 1100° C.

14. An apparatus for ionizing one or more lanthanide isotopes comprising a crucible comprised of a metal that does not readily activate in a neutron field and a heater configured to heat the crucible.

15. The apparatus of claim 14, further comprising a nozzle.

16. The apparatus of claim 14 wherein the heater comprises a DC heating circuit.

17. A system for producing a lanthanide isotopes comprising:
the apparatus for ionizing one or more lanthanide isotopes of claim 14 in fluid communication with an electromagnetic isotope mass separator.

18. The system of claim 17 wherein the electromagnetic isotope mass separator comprises a mass spectrometer.

19. A composition comprising ¹⁵³Sm or a compound comprising ¹⁵³Sm, wherein the composition has a specific activity of about 10 Ci/mg or greater, about 25 Ci/mg or greater, about 50 Ci/mg or greater, about 100 Ci/mg or greater, about 200 Ci/mg or greater, about 300 Ci/mg or greater, or about 400 Ci/mg or greater.
